(19) United States
(12) Patent Application Publication
(10) Pub. No.: US 2003/0035411 A1
(43) Pub. Date: Feb. 20, 2003

(54) Service discovery using a user device interface to an optical transport network

(76) Inventors: John T. Moy, Acton, MA (US); Richard A. Barry, Brookline, MA (US)

Correspondence Address: Daniel P. McLoughlin, c/o Wolf, Greenfield & Sacks, P.C., Federal Reserve Plaza, 600 Atlantic Avenue, Boston, MA, 02210-2211, US

(21) Appl. No.: 09/760,510

(22) Filed: Jan. 12, 2001

Related U.S. Application Data
(60) Provisional application No. 60/176,670, filed on Jan. 18, 2000.
(60) Provisional application No. 60/176,669, filed on Jan. 18, 2000.

(51) Int. Cl. H04L 12/66; H04B 7/212

(52) U.S. Cl. 370/352; 370/443

(57) ABSTRACT

A method of and system for determining an ability of a first device to use an optical trail to communicate across an optical transport network with one or more other devices. The first device and the one or more other devices are external to the optical transport network. A first signal is transmitted from the first device, where the first signal indicates that at least a first port of the first device is available to be an endpoint for an optical trail across the optical transport network. The first signal is received at a first transport network device of the optical transport network. A second signal is transmitted from the first transport network device, where the second signal identifies a second port of a second transport network device included in the optical transport network to which the first device can send signals corresponding to an optical trail. The second signal is received at the first device.

### RELATED APPLICATIONS

This application claims priority under 35 U.S.C. §119(e) to commonly-owned, co-pending U.S. provisional patent applications: Ser. No. 60/176,670, entitled, “OPTICAL DOMAIN SERVICE INTERFACE” filed on Jan. 18, 2000, and Ser. No. 60/176,669, entitled, “GE SIGNALING ARCHITECTURES FOR INTELLIGENT OPTICAL NETWORKS” filed on Jan. 18, 2000, each of which is hereby incorporated by reference in its entirety.

Further, this application is related to commonly-owned U.S. patent applications: “SIGNALING USING A USER DEVICE INTERFACE TO AN OPTICAL TRANSPORT NETWORK”, by John T. Moy et al., “CREATING AN OPTICAL TRAIL ACROSS AN OPTICAL TRANSPORT NETWORK IN RESPONSE TO NETWORK TRAFFIC BETWEEN NETWORK DEVICES EXTERNAL TO THE OPTICAL TRANSPORT NETWORK”, by John T. Moy et al., and “ENCODING SIGNALING INFORMATION AT A PHYSICAL LAYER OF A NETWORK PROTOCOL” by Richard A. Barry et al. (hereinafter the Barry application), each of which was filed on even date herewith and each of which is hereby incorporated by reference in its entirety.

### BACKGROUND

There are several technologies, standards and protocols in use today that enable dynamic provisioning of bandwidth between end points on a network. For example, bandwidth may be provisioned dynamically between end points on a network using the standards for Integrated Services Digital Network (ISDN) transmission, Asynchronous Transfer Mode (ATM) networking, frame relay Switched Virtual Circuit (SVC) transmission, and standards associated with the Public Switched Telephone Network (PSTN).

Recent advances in traffic engineering and constraint-based routing techniques have enabled network devices on networks, for example, Internet Protocol (IP) routers and ATM switches, to determine dynamically when and where they need additional bandwidth. An example of such a traffic engineering technique is described in more detail in RFC 2702 of the Internet Engineering Task Force (IETF): “Requirements for Traffic Engineering Over MPL” (hereinafter RFC 2702), by D. Awduche, J. Malcolm, J. Agogbua, M. O'Dell, and J. McManus, September, 1999, available at: http://www.ietf.org/rfc/rfc2702.txt, which is hereby incorporated by reference in its entirety. Examples of constraint-based routing enhancements to IP routers are discussed in “IS-IS Extensions for Traffic Engineering”, by T. Li and H. Smit, an Internet Draft of the Network Working Group, May, 1999 and “Traffic Engineering Extensions to OSPF”, by D. Katz and D. Yeung, an Internet Draft of the Network Working Group (hereinafter the Katz reference), September 2000, available at: http://search.ietf.org/internetdrafts/draft-ietf-isis-traffic-02.txt, which is hereby incorporated by reference in its entirety.

More recently, optical transport networks (OTNs) are being used to transmit data, including media, control data, informational data and other forms of data. As used herein, an OTN is a network in which all of the network transmission links between network devices are optical transmission links, for example, optical fiber links, although one or more of the network devices may process the transmitted signals non-optically, such as Optical Cross-connects (OXCs) and Add/Drop Multiplexers (ADMs). Typically, on OTNs, bandwidth is provisioned in a relatively slow and static fashion, involving static configuration and redesign of OTN internals that may take days, weeks or months. A new generation of optical switches, however, is enabling dynamic bandwidth provisioning on OTNs, for example, by enabling network operators at network operations centers to provision bandwidth in a point-and-click fashion on the screen of a computer in a network management control system.

Dynamically provisioning bandwidth, however, has not been extended to network devices external to the OTN such that these external devices can provision bandwidth dynamically to communicate across the OTN with other external devices.

### SUMMARY

Provided herein is a user device interface to an Optical Transport Network (OTN). This interface enables dynamic provisioning of bandwidth of an OTN responsive to requests from a network device external to the OTN, so that the network device may communicate across the OTN with another network device external to the OTN. Such dynamic provisioning makes possible a variety of network applications, previously not feasible, that use OTN bandwidth.

In an embodiment, an ability of a first device to use an optical trail to communicate across an optical transport network with one or more other devices is determined, where the first device and the one or more other devices are external to the optical transport network. A first signal is received at an input of a first transport network device of the optical transport network from the first device. The first signal indicates that at least a first port of the first device is available to be an endpoint for an optical trail across the optical transport network. A second signal is transmitted from the first transport network device to the first device. The second signal identifies a second port of a second transport network device included in the optical transport network to which the first device can send signals corresponding to an optical trail.

This embodiment may be implemented as a computer program product that includes a computer readable medium and computer readable signals stored on the computer readable medium that define instructions. These instructions, as a result of being executed by a computer, instruct the computer to perform the acts described above for this embodiment.

In another embodiment, provided is a system for determining an ability of a first device to use an optical trail to communicate across an optical transport network with one or more other devices. The first device and the one or more other devices are external to the optical transport network. The system includes a first transport network device, which includes an input to receive a first signal from the first device, where the first signal indicates that at least a first port of the first device is available to be an endpoint for an optical trail across the optical transport network. The first transport network device also includes an output to transmit to the first device a second signal identifying a second port of a second transport network device included in the optical transport network to which the first device can send signals corresponding to the optical trail.

In another embodiment, provided is a system for determining an ability of a first device to use an optical trail to communicate across an optical transport network with one or more other devices. The first device and the one or more other devices are external to the optical transport network. The system includes: means for receiving a first signal from the first device, the first signal indicating that at least a first port of the first device is available to be an endpoint for an optical trail across the optical transport network; and means for transmitting from the first transport network device to the first device a second signal identifying a second port of a second transport network device included in the optical transport network to which the first device can send signals corresponding to an optical trail.

In another embodiment, an ability of a first device to use an optical trail to communicate across an optical transport network with one or more other devices is determined. The first device and the one or more other devices are external to the optical transport network. A first signal is transmitted to a first transport network device of the optical transport network from the first device. The first signal indicates that at least a first port of the first device is available to be an endpoint for an optical trail across the optical transport network. A second signal is received from the first transport network device. The first signal identifies a second port of a second transport network device included in the optical transport network to which the first device can send signals corresponding to an optical trail.

This embodiment may be implemented as a computer program product that includes a computer readable medium and computer readable signals stored on the computer readable medium that define instructions. These instructions, as a result of being executed by a computer, instruct the computer to perform the acts described above for this embodiment.

In another embodiment, provided is a system for determining an ability of a first device to use an optical trail to communicate across an optical transport network with one or more other devices. The first device and the one or more other devices are external to the optical transport network. The system includes the first device, which includes an output to transmit a first signal to a first transport network device of the optical transport network. The first signal indicates that at least a first port of the first device is available to be an endpoint for an optical trail across the optical transport network. The first device also includes an input to receive a second signal from the first transport network device. The second signal identifies a second port of a second transport network device included in the optical transport network to which the first device can send signals corresponding to an optical trail.

In yet another embodiment, provided is an system of a first device for determining an ability of the first device to use an optical trail to communicate across an optical transport network with one or more other devices. The first device and the one or more other devices are external to the optical transport network. The system includes means for transmitting to a first transport network device of the optical transport network a first signal from the first device. The first signal indicates that at least a first port of the first device is available to be an endpoint for an optical trail across the optical transport network. The system also includes means for receiving from the first transport network device a second signal identifying a second port of a second transport network device included in the optical transport network to which the first device can send signals corresponding to an optical trail.

In another embodiment, an ability of a first device to use an optical trail to communicate across an optical transport network with one or more other devices is determined. The first device and the one or more other devices are external to the optical transport network. A first signal is transmitted from the first device, where the first signal indicates that at least a first port of the first device is available to be an endpoint for an optical trail across the optical transport network. The first signal is received at a first transport network device of the optical transport network. A second signal is transmitted from the first transport network device, where the second signal identifies a second port of a second transport network device included in the optical transport network to which the first device can send signals corresponding to an optical trail. The second signal is received at the first device.

This embodiment may be implemented as a computer program product that includes a computer readable medium and computer readable signals stored on the computer readable medium that define instructions. These instructions, as a result of being executed by a computer, instruct the computer to perform the acts described above for this embodiment.

In another embodiment, provided is a system for determining an ability of a first device to use an optical trail to communicate across an optical transport network with one or more other devices. The first device and the one or more other devices are external to the optical transport network. The system includes the first device, which includes a first output to transmit a first signal indicating that at least a first port of the first device is available to be an endpoint for an optical trail across the optical transport network. The first device also includes a first input to receive a second signal identifying a second port of a second transport network device included in the optical transport network to which the first device can send signals corresponding to an optical trail. The system also includes a first transport network device, which includes a second input to receive the first signal and a second output to transmit the second signal.

In yet another embodiment, provided is a system for determining an ability of a first device to use an optical trail to communicate across an optical transport network with one or more other devices. The first device and the one or more other devices are external to the optical transport network. The system includes means for transmitting from the first device a first signal indicating that at least a first port of the first device is available to be an endpoint for an optical trail across the optical transport network, and means for receiving the first signal at a first transport network device of the optical transport network. The system also includes means for transmitting from the first transport network device a second signal identifying a second port of a second transport network device included in the optical transport network to which the first device can send signals corresponding to an optical trail, and means for receiving the second signal at the first device.

### BRIEF DESCRIPTION OF THE DRAWINGS

The features and advantages of the embodiments described above and other features and advantages of these embodiments will be more readily understood and appreciated from the detailed description below, which should be read together with the accompanying drawing figures.

In the drawings,

FIG. 1 is a block diagram illustrating an example embodiment of a network that includes an optical transport network and a user device interface to the optical transport network;

FIG. 2 is a block diagram illustrating an example embodiment of the optical transport network of FIG. 1;

FIG. 3 is a block diagram illustrating an example embodiment of a user device interface between a user device of FIG. 1 and the optical transport network of FIG. 1;

FIG. 4 is a block diagram illustrating an example embodiment of an optical trail;

FIG. 5 is a block diagram illustrating an example embodiment of a user device interface between a user device and a transport network device of an optical transport network;

FIGS. 6A-6B are a flowchart illustrating an example embodiment of a method of creating an optical trail across an optical transport network in response to a request from a device external to the optical transport network;

FIG. 7 is a block diagram illustrating an example embodiment of a signal requesting creation of an optical trail;

FIG. 8 is a block diagram illustrating an example embodiment of a logical topology of the network of FIG. 1;

FIG. 9 is a block diagram illustrating an example embodiment of a full-mesh overlay of Label Switched Paths between user devices of the network of FIG. 1; and

FIG. 10 is a flow chart illustrating an example embodiment of a method of creating an optical trail across an optical transport network in response to network traffic.

### DETAILED DESCRIPTION

1. Overview

Described herein is a user device interface to an Optical Transport Network (OTN), hereinafter referred to as an Optical Transport Network User Device Interface (OTNUDI). Such an interface may enable devices external to the OTN, hereinafter referred to as “User Devices” or “UDs”, to request bandwidth dynamically from the OTN, and enables the OTN, in response to the request, to provision dynamically the OTN bandwidth to an optical trail across the OTN that terminates at each end to a UD. An optical trail also may be referred to as an optical circuit. Such an optical trail may be comparable to a leased line on the OTN, such that, after being created, the optical trail may be used exclusively by the two endpoint UDs until the optical trail is deleted (i.e., removed).

Optionally, as described below in more detail, an OTNUDI may support use of a variety of protocols to discover service on an OTN, register addresses on the OTN and signal a request to the OTN for the creation of an optical trail. Such protocols may be modified or enhanced to support characteristics unique to the OTN. For example, Internet Protocol (IP) addressing and the Transport Control Protocol (TCP) may be extended to support signaling a request to create an optical trail transmitted to the OTN.

The OTNUDI may be used to implement a variety of applications. For example, an application may integrate OTNUDI, known traffic engineering techniques for electrical networks (e.g., those discussed in RFC 2702), and known traffic engineering techniques for OTNs (e.g., those discussed in “Multi-Protocol Lambda Switching: Combining MPLS Traffic Engineering Control with Optical Crossconnects” by D. Awduche et al. (hereinafter the Awduche reference), an Internet Draft of the IETF, July, 2000, available at: http://search.ietf.org/internet-drafts/draft-awduche-mpls-te-optical02.txt). The Awduche reference, which is hereby incorporated by reference in its entirety, provides an example implementation of the internals of an OTN.

Various aspects of OTNUDI, including service discovery, address registration and signaling may be implemented in accordance with Optical Domain Service Interconnect (ODSI), as described below in more detail, for example, as promulgated by the ODSI Coalition. The ODSI Coalition has a web page at: http://www.odsicoalition.com/documents.html, from which the most recent versions of various documents specifying different aspects of ODSI may be accessed. The current versions of some of these documents are included in Appendices I-V, as described in more detail below.

2. Network Infrastructure

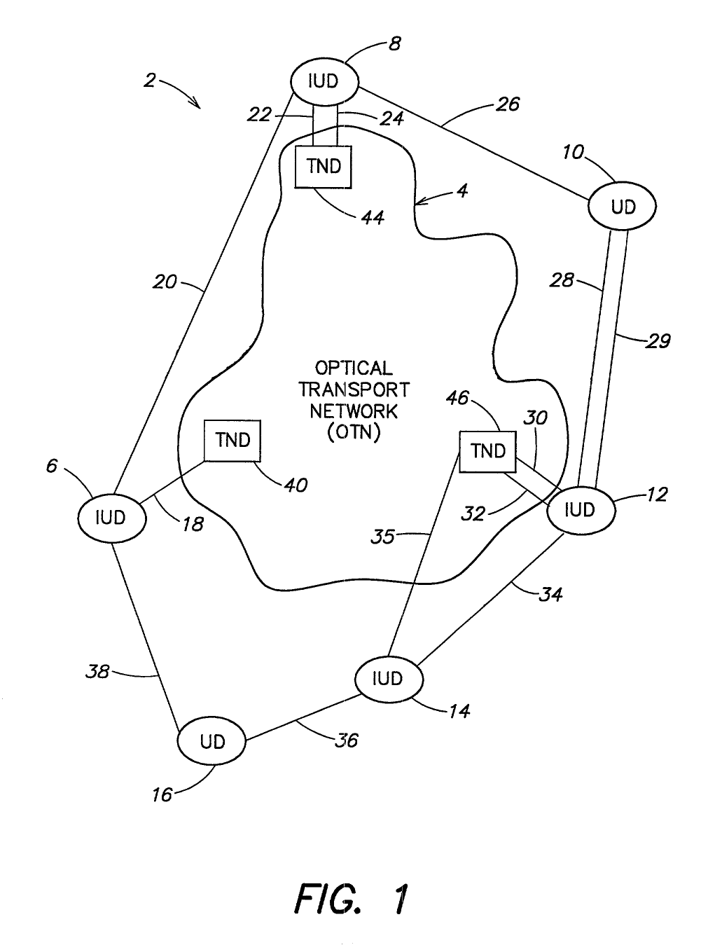

FIG. 1 is a block diagram illustrating an example embodiment of a network 2 that may implement an OTNUDI. The network 2 may include an OTN 4, a plurality of UDs 6, 8, 10, 12, 14 and 16, and a plurality of network links 18, 20, 22, 24, 26, 28, 29, 30, 32, 34, 35, 36 and 38. A network link is a physical connection (i.e. a physical interface) between two network devices. A network link may be an optical link, for example, a fiber optic cable, or an electrical link, for example, an electrical wire or cable.

A UD that is interfaced physically to the OTN by an optical link (e.g., a fiber optic cable) may be referred to herein as an interfaced UD or an IUD. Thus, IUDs are a subset of UDs and, unless otherwise specified, descriptions herein of UDs also apply to IUDs.

An IUD may serve as an endpoint of an optical trail across an OTN, e.g., the OTN 4, and may transmit signaling requests to the OTN, where the request may correspond to an optical trail. UDs not connected directly to the OTN may not be used as an endpoint for an optical trail, but, as described in more detail below, may transmit a signaling request to an OTN, where the request may correspond to an optical trail.

Each of the UDs may be any of a variety of UDs capable of receiving and transmitting signals, and capable of any of a various combinations of the following functions: receiving electrical signals, receiving optical signals, converting electrical signals into optical signals, converting optical signals into electrical signals, processing (e.g., multiplexing, switching, routing, etc.) electrical signals, processing optical signals, transmitting electrical signals, and transmitting optical signals. The physical links (e.g., electrical or optical links) between two of these UDs should be consistent with the receiving and transmitting capabilities of the two UDs, in particular, such capabilities of the ports of the two UDs that are physically interfaced by the physical links.

A UD may be an IP router such as the M40/M160 available from Juniper Networks, Inc. of Sunnyville, Calif., an ATM switch such as the GX550 available from Lucent Technologies of Murray Hill, N.J., an ADM such as the DDM available from Lucent Technologies of Murray Hill, N.J., or an OXC such as the SN 16000 available from Sycamore Networks of Chelmsford, Mass.

SONET is described in more detail in various texts and in Bellcore Generic Requirements, GR-253-CORE, Synchronous Optical Transport Network (SONET) Transport Systems: Common Generic Criteria, Issue 2, December 1995 (hereinafter GR-253), which is hereby incorporated by reference in its entirety.

The network 2 may include a plurality of external network links 20, 26, 28, 29, 34, 36 and 38 that are external to the OTN 4, and a plurality of user device interface (UDI) links 18, 22, 24, 30, 32 and 35 that each physically interface a IUD to the OTN 4. For example, UDI link 24 physically interfaces IUD 8 to transport network device (TND) 44 of OTN 4.

Each external link 20, 26, 28, 29, 34, 36 and 38 may be any of a variety of kinds of network links, including an optical link (e.g., a fiber optic link) or an electrical link (e.g., an electrical wire or cable). An electrical link may be any of a variety of kinds of electrical links, such as a 10BaseT Ethernet cable. An optical link may have any of a variety of bit transmission rates and one or more of these bit transmission rates may correspond to any of a variety of SONET levels and/or Synchronous Digital Hierarchy (SDH) levels. For example, an optical link may have a bit transmission rate of 2.488320 Gigabits per second (Gbps) corresponding to a SONET Optical Carrier (OC) level of OC-48 and an SDH Synchronous Transport Module (STM) level of STM-16.

Each external link may terminate at each end to a UD. For example, external link 36 terminates at one end at IUD 14 and at the other end at UD 16.

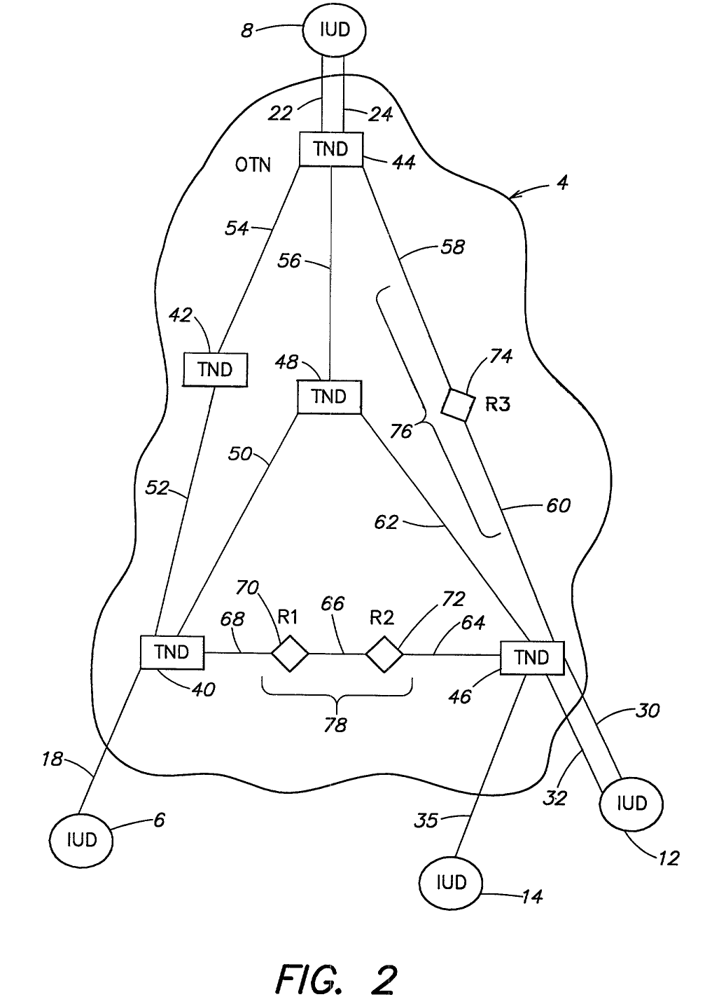

An IUD may be physically interfaced to a TND by one or more UDI links, where at least one UDI link is an optical link and any other UDI links are any of a variety of types of network links, e.g., an optical link or an electrical link. A UDI link may terminate at one end to a port of an IUD, and at the other end to a port of a TND of the OTN, described in more detail below in relation to FIG. 2. For example, UDI link 35 terminates at one end at IUD 14 and at the other end at TND 46.

FIG. 2 is a block diagram illustrating an example embodiment of the OTN 4 in more detail. The OTN 4 is a plurality of inter-connected network devices and one or more optical links that may be used to create an optical trail between two UDs. The OTN 4 may include a plurality of Transport Network Devices (TNDs), including TNDs 40, 42, 44, 46 and 48. Each of the TNDs of the OTN 4 may be any of a variety of network devices that are capable of: receiving and transmitting optical signals; and either processing optical signals or converting optical signals to electrical signals, processing electrical signals and converting electrical signals into optical signals. Such devices may include OXCs, ADMs, and other capable devices.

As described above, each TND may be linked to an IUD of the network 2 by one or more UDI links. For example, TND 44 is linked to IUD 8 by UDI links 22 and 24; TND 46 is linked to IUD 12 by UDI links 30 and 32 and to IUD 14 by UDI link 35; and TND 40 is linked to IUD 6 by UDI link 18.

If a TND, e.g., TND 44, is linked to a IUD, e.g., IUD 8, by more than one UDI link, e.g., UDI links 22 and 24, each of these UDI links may be of the same or a different type. For example, UDI link 22 may be an optical link and UDI link 24 may be an electrical link. Further, as will be described below in more detail, if more than one UDI link connects a TND to an IUD, then each UDI link may serve a different function. For example, UDI link 22 may be an optical link serving as part of an optical trail across the OTN 4 that includes IUD 8 as an endpoint, and UDI link 24 may be an electrical link on which signals, e.g. control signals, corresponding to the optical trail are transmitted from the IUD 8 to the OTN 4.

The OTN 4 also may include a plurality of internal links that are internal to the OTN 4, including internal links 50, 52, 54, 56, 62, 76 and 78, where each of these internal links is an optical link such as a fiber optic cable. Some of these internal links may be divided into sections by regenerators. For example, internal link 76 is divided into segments 58 and 60 by regenerator 74, and link 78 is divided into segments 64, 66 and 68 by regenerators 70 and 72.

The network 2 and the OTN 4 are merely illustrative examples of networks on which an OTNUDI may be implemented. Several other implementations of network 2 and OTN 4 may be used to implement an OTNUDI.

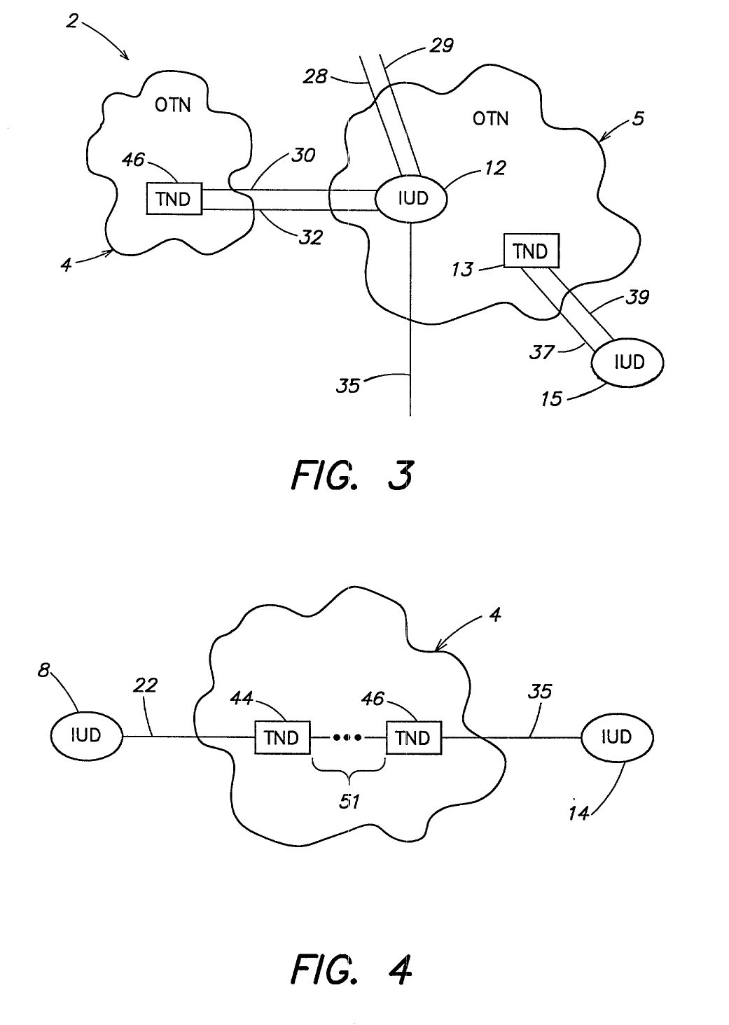

For example, any of the IUDs of the Network 2 also may serve as a TND of another OTN, as illustrated in FIG. 3. FIG. 3 is a block diagram illustrating an example of an embodiment of the Network 2 in more detail, where IUD 12 also serves as a TND of another OTN 5. For example, OTN 4 may be a Metropolitan Area Network (MAN) controlled by a first service provider, and OTN 5 may be the optical core of a Wide-Area Network (WAN) that includes this MAN.

Similar to OTN 4, OTN 5 may include one or more other TNDs, for example, TND 13, where each of the one or more TNDs has the same capabilities as the TNDs of OTN 4 described above. Further, OTN 5 may include a plurality of optical links (not shown) interconnecting the plurality of TNDs. Each of the TNDs may be interfaced to one or more IUDs by one or more UDI links. For example, TND 13 is interfaced physically to IUD 15 by UDI links 37 and 39.

From the perspective of OTN 4, network device 12 is an IUD, whereas from the perspective of OTN 5, network device 12 is a TND. Similarly, from the perspective of OTN 5, network device 46 is an IUD, and from the perspective of OTN 4, network device 46 is a TND. Accordingly, the service discovery, address registration, and signaling methods and systems described below apply to network devices, e.g., 12 and 46, that serve a role as both an OND and IUD.

As used herein, an “optical trail” is a logical connection between two IUDs across an OTN. An optical trail includes at least: a first endpoint, which is an IUD; a first TND; a first UDI link physically interfacing the first endpoint and the first TND; a second TND; at least a first internal link (internal to the same OTN as the first and second TNDs) connecting the first and the second TNDs; a second endpoint, which is an IUD; and a first UDI link that physically interfaces the second endpoint to the second TND. An optical trail also may include one or more other internal links (internal to the same OTN as the first and second TNDs) and one or more other TNDs of the same OTN, where the one or more internal links and the one or more other TNDs together form a connection between the first and second TNDs.

FIG. 4 is a block diagram illustrating an example embodiment of an optical trail that may be created across the OTN 4 of FIG. 1. This optical trail may include IUD 8, UDI link 22, TND 44, one or more internal links and possibly one or more other TNDs of the OTN 4, 51, TND 46, UDI link 35 and IUD 14.

Each UDI link included in an optical trail is associated with a port of an IUD and a port of a TND. For some UDI links, the available bandwidth on the UDI link may be allocated to a single logical connection, for example, a single optical trail, and thus the IUD port of the UDI link is associated with a single optical trail.

A UDI link also may be divided into a plurality of channels, where each channel corresponds to a particular logical connection. In such a case, the IUD port of the UDI link may correspond to multiple logical connections, where one or more of the connections may be an optical trail.

In order to transmit signals on a UDI link divided into multiple channels, a variety of multiplexing techniques may be used, including Space-Division Multiplexing (SDM), Time-Division Multiplexing (TDM), Statistical Time-Division Multiplexing (STDM), Frequency-Division Multiplexing (FDM), and, for optical links only, Wave-Division Multiplexing (WDM) and Dense Wave-Division Multiplexing (DWDM). For example, a UDI link implemented using a SONET physical layer may use TDM to divide the UDI link into multiple timeslots (i.e., channels), where each timeslot corresponds to a particular logic connection, for example, an optical trail.

A TND of the OTN 4 may be configured to use Wave-Division Multiplexing (WDM), for example, dense WDM (DWM) to communicate with other TNDs of the OTN 4. Accordingly, the TND may be configured to map a channel (i.e., timeslot) of a UI link to a specific wavelength of light corresponding to the channel and transmit the channel as part of an optical signal on an internal link of the OTN 4.

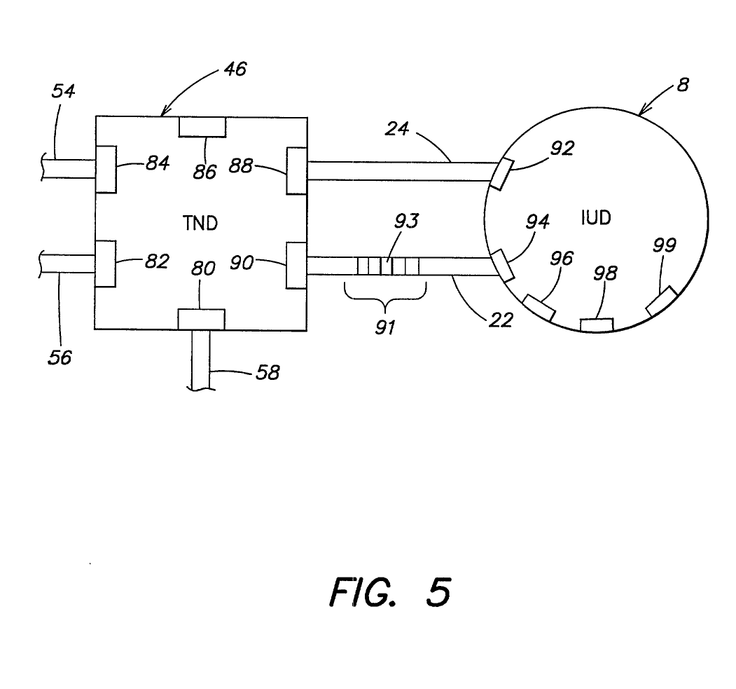

FIG. 5 is a block diagram illustrating an example of an embodiment of a more detailed view of the physical interface between TND 46 and UD 8. TND 46 may include a plurality of ports 80, 82, 84, 86, 88 and 90. Port 80 may be interfaced to internal link 58, port 82 to internal link 56, port 84 to internal link 54, port 88 to UDI link 24 and port 90 to UDI link, and port 96 may be idle.

UD 8 may include a plurality of ports 92, 94, 96, 98 and 99. Port 92 may be interfaced to UDI link 24 and port 94 to UDI link 22, and ports 96, 98 and 99 may be idle.

UI link 22 may be an optical link divided into a plurality of channels 91, of which one channel, 93, may be associated with a first optical trail. Thus, data transmitted between UD 8 and TND 46 for the first optical trail is transmitted within channel 93.

Each TND of the OTN, including Transport Network Controllers (TNCs), described below in more detail, and each UD may be configured with logic to implement at least a portion of the various OTNUDI functions described below, including, various techniques for service discovery, address registration and optical trail signaling. Such logic may be implemented using hardware (e.g., one or more application-specific integrated circuits) , firmware (e.g., electrically-programmable logic), software, or a combination thereof. Each TND or UD may include, among other things, a plurality of known components such as one or more processors, a memory system, a disk storage system, one or more network interfaces connecting the TND to network links that connect to other network resources, components for processing (e.g., multiplexing, switching, routing, converting, etc.) network signals and data, and one or more busses or other internal communication links interconnecting the various components.

Further, each TND and UD may be configured to communicate with other network resources, including other TNDs and UDs and databases, to implement the various OTNUDI functions.

3. Service Discovery

After a port of an IUD has been connected physically to the OTN 4, e.g., by a UDI link, it may be desirable for the IUD to determine whether it can request creation of and serve as an endpoint for an optical trail across the OTN 4. As used herein, the process of an IUD determining its ability to create and serve as an endpoint for an optical trail across an OTN is referred to as “service discovery.”

For example, for a first IUD, e.g., IUD 8, having a first port physically interfaced to the OTN 4, the following service discovery method may be used by the first UD.

In a first act, the first IUD may send a first signal to a physically interfaced (i.e., adjacent) TND of the OTN 4, for example, TND 44 of the OTN 4. This first signal may indicate that the first port of the first IUD is available to request creation of and serve as an endpoint for an optical trail, and may be sent on a UDI link physically interfaced to the first port, on which optical traffic may be transmitted between the IUD and the TND.

In addition to identifying the first port of the first IUD, the first signal also may include other information corresponding to the first IUD. For example, the first signal also may include a user group ID signal identifying a user group to which the first port belongs. Such a user group may include as members a plurality of ports corresponding to UDs of the network 2. Some ports may be from a same UD whereas other ports may be from different UDs. As will be described in more detail below, such a user group identification signal may be used for accounting purposes and for security to authorize the creation of an optical trail across the OTN 4 between two IUDs, for example, as described in Appendix I, which is a copy of “COPS Usage for ODSI”, Version 2.0, by N. Ghani et al., ODSI Coalition, August 2000. For authorization purposes, the first signal also may include a digital signature of the first IUD to verify that the first signal was sent from the first IUD.

Further, the first signal also may include one or more port characteristic signals, where each port characteristic signal indicates a physical characteristic of the first port of the first UD. For example, one or more of the port characteristic signals may indicate an ability of the first port to support concurrently a plurality of channels, and therefore, an ability to support concurrently a plurality of optical trails.

The first signal may reserve fields for vendors to provide proprietary information that may be used for a variety of purposes, such as for specifying a protection mode, e.g., ring or linear SONET Automatic Protection Switching (APS), for all optical trails to be created that include a port of the first IUD as an endpoint. Other information may be included in the first signal.

Other than the identification of the first IUD and the first port, the information described above that may be included in the first signal alternatively may be included in one or more other service discovery signals in various combinations. These other service discovery signals may be sent from a port other than the first port, and may be sent from an IUD other than the first IUD on behalf of the first IUD.

In a next act, in response to receiving the first signal, the OTN 4, for example, adjacent TND 44 of the OTN 4, may transmit to the first IUD a second signal that comprises a TNC ID signal that identifies a TND of the OTN 4 to which the first IUD should send optical trail signals.

As used herein, an “optical trail signal” is a signal corresponding to an optical trail. Optical trail signals are described in more detail below.

As used herein, a “Transport Network Controller” or “TNC” is a TND of the OTN to which an IUD can send optical trail signals. The adjacent TND and the TNC may be a same or different TND. As is described in detail below, a TNC may be configured to perform operations corresponding to an optical trail. Other OTN resources, such as other TNDs and databases may assist a TNC in performing such operations. If an operation is described below as being performed by a TNC, it should be understood that other OTN resources may assist the TNC in performing the operation.

In addition to identifying the TNC, the second signal may include other information. For example, the second signal may include an acknowledgement signal acknowledging to the first IUD that the OTN 4, in particular, the TNC, is aware that the first port of the first IUD is available to be allocated the optical trail. Further, the second signal may include one or more OTN characteristic signals, where each OTN characteristic signal indicates a characteristic of the OTN. For example, an OTN characteristic signal may indicate an ability of the OTN to route concurrently a plurality of optical trails.

Further, the second signal may include an indication that for address registrations and signaling requests, the first IUD should supply information, e.g., a digital signature, for authentication.

The second signal also may include an indication of a typical optical trail set-up time, e.g., in milliseconds. The first IUD then may use this information to determine whether to request creation of an optical trail and, if it does make such a request, to determine whether it should abandon the request after a certain amount of time has elapsed and possibly submit a new request or pursue some other option.

Further, the second signal may include the IP address of the adjacent TND (e.g., TND 44) of the OTN 4, and may include a port ID (e.g., if Index) of a port of the adjacent TND. As described in more detail below, if a UD subsequently requests the creation of an optical trail across the OTN 4 that includes the first IUD as an endpoint, the UD may specify the IP address and/or port ID of the adjacent TND as the endpoint of its optical trail request.

Other information may be included in the second signal. Further, this other information and the information described above that may be included in the second signal alternatively may be included in one or more other service discovery signals in various combinations. These other service discovery signals and the second signal may be sent to a port of the first IUD other than the first port, and may be sent to an IUD other than the first IUD, where such an IUD then may transmit the information included in such signals to the first IUD.

The adjacent TND may store and retrieve information from a database, for example, a Management Information Base (MIB). Such a database may include one or more tables that store a variety of information, including network management information, routing information, network configuration parameters, and information about TNDs, ports and channels of TNDs, UDs, ports and channels of UDs, etc. Such a database may include a table or other database structure that includes a plurality of entries, where each entry corresponds to a UD, port or channel, and where each entry may include parameters and other information corresponding to a UD, port or channel, respectively.

This database may be accessed by TNDs during service discovery, address registration, and signaling (i.e., in response to optical trail signals) An instance of such a database, or at least part of such an instance, may be stored on one or more TNDs, one or more UDs or any combination thereof. For illustrative purposes, such a database may be referred herein to as an MIB.

Such an MIB may be implemented as described in Appendix II, which is a copy of “Definition of Managed Objects for ODSI Management”, Version 1.5, by K. Arvind et al., ODSI Coalition, October 2000.

Optionally, service discovery, including the exchange of the first, second, and possibly other signals, may be performed in accordance with the Link Control Protocol (LCP) of the Point-to-Point Protocol (PPP). PPP and LCP are described in more detail in IETF RFC 1661: “The Point-to-Point Protocol (PPP)”, by W. Simpson, July 1994, available at: http://www.ietf.org/rfc/rfc1661.txt, which is hereby incorporated by reference in its entirety.

The exchange of the first signal and the second signal described above may create a service discovery connection between the first IUD and a TND of the OTN 4, for example, a PPP session, where the termination points for such a service discovery connection may be the first IUD, e.g., UD 8, and the adjacent TND of the OTN 4, e.g., TND 44, to which the first IUD is directly connected.

This service discovery connection may be tested periodically to ascertain whether the connection remains “live”. For example, the service discovery connection may be tested in accordance with an extension of the Link Quality Monitoring Protocol (LQMP) of PPP. LQMP is described in more detail in IETF RFC 1989: “PPP Link Quality Monitoring” by W. Simpson, August 1996, (hereinafter RFC 1989), available at: http://www.ietf.org/rfc/rfc1989.txt, which is hereby incorporated by reference in its entirety.

It may be determined during this testing that a service discovery connection has failed. As will be described below in more detail, after determining an ability to create and serve as an endpoint for an optical trail across the OTN 4, the first IUD may register, with the OTN 4, IP addresses for its ports and request creation of optical trails across the OTN 4. Accordingly, if it is determined that a service discovery connection has failed, any registered IP addresses associated with the first port of the first IUD may be removed, but any existing optical trails that include the first port may be maintained.

Optionally, the first signal, second signal and any other service discovery signals exchanged between a IUD and the OTN 4 during service discovery may be transmitted in accordance with SONET. Each of the first signal, second signal, or other service discovery signals may be included within a SONET frame, for example, as part of the overhead bytes of a SONET frame. Specifically, service discovery signals may occupy the SONET Line Data Communication Channel (DCC) contained within the line overhead bytes of a first STS-1 time slot of a SONET frame on a UDI link between a port of a UD and an adjacent TND of the OTN 4. SONET overhead bytes are described in more detail in the aforementioned GR-253.

4. Address Registration

To enable a port of an IUD to be used as an endpoint of an optical trail, one or more IP addresses may be registered for the port. Further, for each registered IP address, a user group may be associated with the IP address. This associated user group may be used for accounting and security purposes. As is described below in more detail, each of these IP addresses may be used in a request for an optical trail to identify the port as an endpoint for the optical trail.

To register one or more IP addresses to a port, an IUD, e.g., IUD 14, may send a signal to the OTN 4, more specifically to a TND, e.g., TND 46, of the OTN 4. This signal may include one or more IP addresses to associate with the port.

Optionally, this signal may be transmitted to the OTN 4 in accordance with SONET. The signal may be included within a SONET frame, for example, as part of the overhead bytes of a SONET frame, in a same or similar manner to that described above in relation to service discovery signals.

Optionally, an IUD may register a same IP address for multiple ports of the IUD. As will be described in more detail below, for requests to create an optical trail, a specific port ID may not be included in the request. Accordingly, if a same IP address is registered for multiple ports, and a specific port is not specified in an optical trail request, but an IP address is specified, the OTN 4, e.g., a TNC of the OTN 4, may be configured to select one of the ports of the IUD that are registered with the specified IP address to serve as an endpoint for the optical trail.

Further, multiple IP addresses may be registered for a single port of an IUD. For example, the port may be interfaced physically to a UDI link divided into a plurality of channels, where each channel corresponds to a different logical connection, e.g., an optical trail. Accordingly, for each channel, a different IP address may be registered for the port.

As an alternative to exchanging service discovery signals and registering IP addresses, an IUD and/or one or more TNDs may be configured manually to enable the IUD to request creation of and serve as an endpoint for an optical trail.

Optionally, service discovery signals may be exchanged and IP addresses registered as described in Appendix III, which is a copy of “Optical Domain Service Interconnect (ODSI) Functional Specification”, Version 1.4, the ODSI Coalition, August 2000, and as described in Appendix IV, which is a copy of: “ODSI Service Discovery and Address Registration”, Version 1.1, by G. Bernstein et al., the ODSI Coalition, April 2000.

5. Signaling

After an IUD has determined that it has the ability to request creation of and serve as an endpoint for an optical trail across the OTN 4, and the IUD has registered one or more IP addresses for one or more of its ports, the IUD and other IUDs of the network 2 may request that an optical trail be created between the IUD and another IUD across the OTN 4, as well as send other optical trail signals.

Types of optical trail signals may include a trail creation signal to request creation of an optical trail, a delete signal to request deletion of an optical trail, a query signal to query the status of an optical trail, a destructive modify signal to request modification of an optical trail, a non-destructive modify signal to request modification of the optical trail, and a look-up signal to request a list of valid optical trail endpoints. Each of these signals is described in more detail below.

Optical trail signals corresponding to an optical trail may be transmitted as IP messages. Further, these optical trail signals may be transmitted in accordance with a straightforward extension to a number of known protocols such as protocols used by Multiprotocol Label Switching (MPLS), for example, the Resource Reservation Setup Protocol (RSVP) (e.g., as described in IETF RFC 2205: “Resource ReSerVation Protocol (RSVP)—Version 1 Functional Specification”, by R. Braden et al., September 1997, available at: http://www.ietf.org/rfc/rfc2205.txt, “RSVP Refresh Reduction Extensions”, by L. Berger et al., an Internet Draft of the Network Working Group, June 2000, available at: http://search.ietf.org/internet-drafts/draft-ietf-rsvp-refresh-reduct-05.txt, and “RSVP-TE: Extensions to RSVP for LSP Tunnels”, by D. Awduche et al., an Internet Draft of the Network Working Group, August 2000, available at: http://search.ietf.org/internet-drafts/draft-ietf-mpls-rsvp-lsp-tunnel-07.txt, where each reference is hereby incorporated by reference in its entirety) and the Label Distribution Protocol (LDP) (e.g.. “LDP Specification”, by L. Andersson et al., an Internet Draft of the Network Working Group, August 2000, available at: http://search.ietf.org/internetdrafts/draft-ietf-mpls-ldp-11.txt and “Constraint-Based LSP Setup using LDP”, by B. Jamoussi et al., an Internet Draft of the Network Working Group, July 2000, available at: http://search.ietf.org/internet-drafts/draft-ietf-mpls-cr-ldp-04.txt, where each reference is hereby incorporated by reference in its entirety).

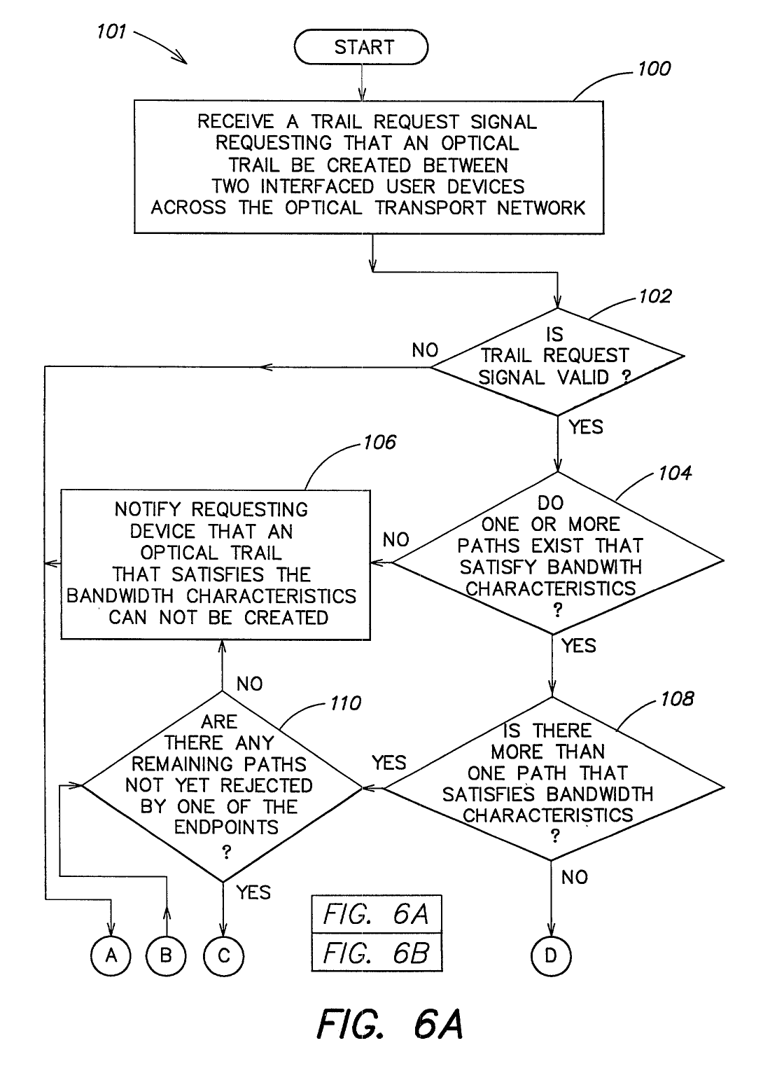

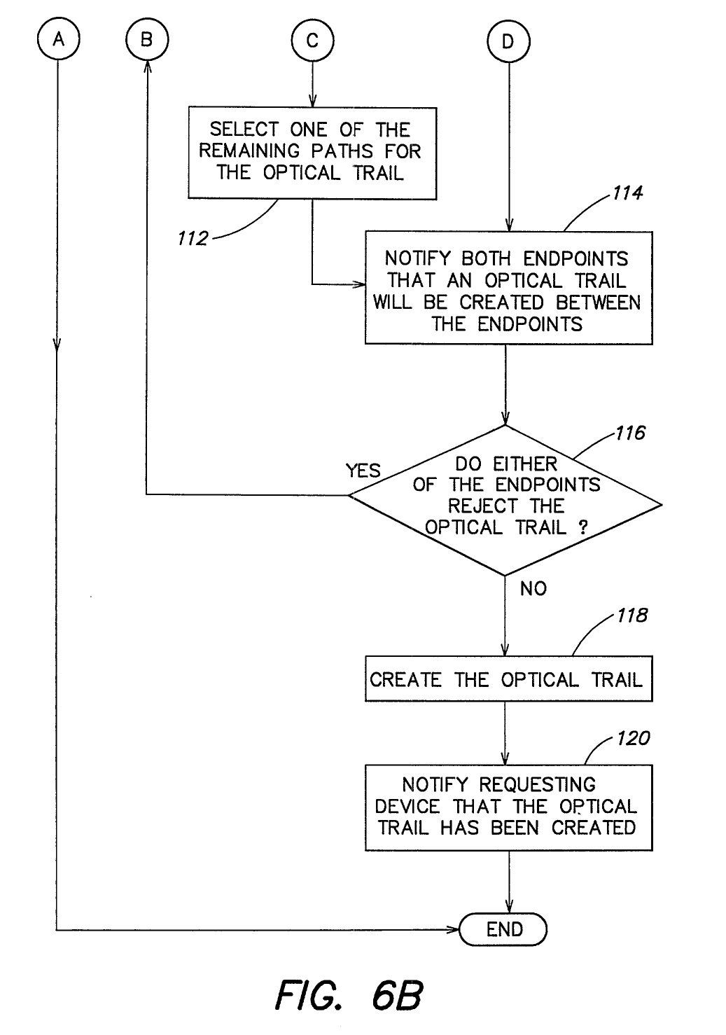

FIGS. 6A-6B are a flow chart illustrating an example embodiment of a method 101 of creating an optical trail across an OTN between a first IUD and a second IUD.

In Act 100, a request for an optical trail to be created between two IUDs (i.e., a trail creation signal) may be received, for example, by a TNC. This trail creation signal, and other optical trail signals described below, may be transmitted by a requesting device. A requesting device may be an IUD to be included as an endpoint of the optical trail, an IUD that is not to be included as one of the endpoints of the optical trail, or by another UD. For example, the trail creation signal indicating a request to create an optical trail across the OTN 4 between IUD 8 and IUD 12 may be transmitted from IUD 8 to TND 44 to TND 48, which may be a TNC. Alternatively, the trail creation signal may be transmitted from IUD 14 to TND 46 to TND 48. Further, the trail creation signal may be transmitted from UD 16 to IUD 14 to TND 46 to TND 48.

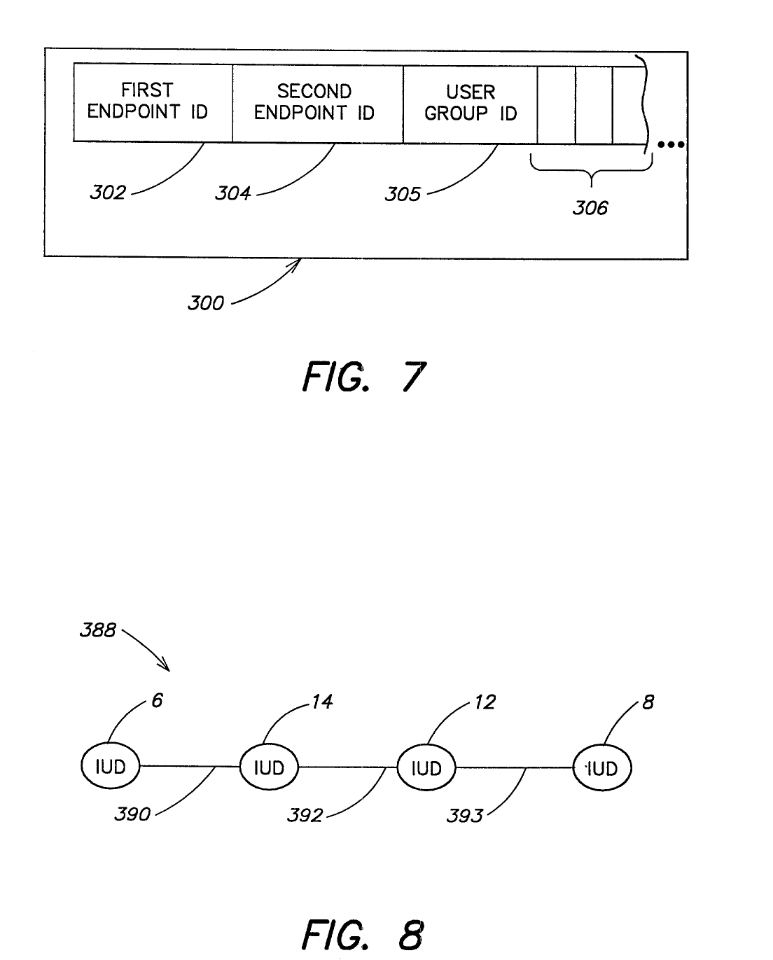

FIG. 7 is a block diagram illustrating an example embodiment of a trail creation signal 300. The trail creation signal 300 may include a variety of information, including an identification of each of the endpoints for the optical trail, e.g., first endpoint ID 302 and second endpoint ID 304, and one or more trail parameter signals 306. Each trail parameter signal may specify a parameter requested for the optical trail.

The trail creation signal 300 also may include a user group ID 305, which should specify a user group to which the requesting device and both endpoints belong. In addition to including a user group, for authentication, the trail creation signal 300 also may include a digital signature of the requesting device to verify the identification of the requesting device.

For each endpoint ID 302 and 304, the endpoint ID may be a combination of one or more of the following parameters: an IP address of an IUD, the IP address associated with one or more ports of the IUD; a port index, for example, an ifIndex, identifying a particular port of an IUD; and a channel ID identifying a channel of a port of an IUD.

The optical trail parameters specified by the trail parameter signals may include, among others: a physical layer indication, a size indication, a priority indication, a protection indication, a propagation delay indication, a jitter indication, a bit error rate indication, an availability indication, a diversity indication and a vendor extension indication, as well as other optical trail parameters.

The physical layer indication specifies the physical layer technology, for example, SONET, Gigabit Ethernet (GE), or a digital wrapper connection, to be used to encode data on the optical trail. Other physical layer technologies may be specified.

The size indication specifies the requested size of the optical trail to be created. The size may be specified using any of a variety of metrics, for example, bits per second (e.g., 51.840 Mbps), or sizes of STS-1, OC-48, or STM-16(i.e., size specifications corresponding to an optical link), or sizes of one or ten Megabits (i.e., size specifications corresponding to an electrical link, such as an Ethernet cable). Any size bandwidth may be requested, although the size requested may not be supported by the OTN 4 and, consequently, the requested optical trail may not be granted.

The priority indication specifies whether the optical trail may be preempted by other, higher priority optical trails, or vice versa.

The protection indication specifies whether the optical trail is protected against failures. Further, the protection indication may indicate a particular technique or mechanism to use to protect the optical trail. If the protection indication specifies that the optical trail is protected against failures, the protection indication also may communicate the speed at which the protection will restore the optical trail after a failure. Such a speed indication may be specified in any of a number of units, for example, milliseconds.

The propagation delay indication specifies a maximum amount of propagation delay acceptable for the optical trail, and may be given in any of a variety of units, for example, milliseconds.

The jitter indication specifies a maximum amount of jitter acceptable for the optical trail. The amount of jitter may be specified in any of a variety of units, for example, microseconds.

The bit error rate indication specifies a maximum error rate acceptable for the optical trail. The error rate may be specified in any of a variety of units, for example, the error rate may be specified as an exponent of the actual error rate. For example, 10⁻⁹ may be specified as the integer 9.

The availability indication specifies a request for a guarantee of bandwidth availability. For example, the availability indicator may request that the bandwidth be available for a specific amount of seconds, minutes, hours or days per year, or be available for all but a specified amount of time per year.

The diversity indication specifies a request that the optical trail not share a common facility with (i.e., be diverse from) one or more specified already existing optical trails.

The vendor extension indication may be used to allow vendors to specify their own proprietary or custom bandwidth descriptions. For example, a vendor may use the vendor extension indicator to specify a protection mode, such as ring or linear SONET Automatic Protection Switching (APS).

One or more of the IUDs of the network 2, one or more of the TNDs, or a combination thereof may be configured such that only certain optical trail parameters may be specified, and/or only certain parameters may be granted in response to a request. Further, one or more IUDs and TNDs may be configured such that certain limits are imposed on optical trail parameters that may be requested and/or granted. For example, the size of an optical trail may be limited to 2.488320 Gbps (i.e., OC-48), and availability guarantees may be limited to a particular number of days or hours per year.

As described above, a trail creation signal may be transmitted from a requesting device, such as a IUD, that is not part of the optical trail being requested. Accordingly, the trail creation signal, as well as other optical trail signals, may travel a different path than the optical trail that may be created as a result of the trail creation signal.

A trail creation signal, as well as other optical trail signals, may be transmitted along multiple internal links within the OTN 4 until it reaches the TNC of the OTN 4 that contains logic to determine the path of the optical trail across the OTN 4.

A trail creation signal, and any of the other optical trail signals described below, corresponding to a first optical trail may be transmitted between an endpoint and a TND of the first optical trail on a UDI link of the first optical trail, in which case the optical trail signal may be referred to as being transmitted “in-band”. For example, for a first optical trail (existing or to be created) between IUD 8 and IUD 6 that includes UDI link 22, an optical trail signal corresponding to the first optical trail transmitted on UDI link 22 is an in-band optical trail signal.

Alternatively, a trail creation signal, and any of the other optical trail signals described below, corresponding to a first optical trail may not be transmitted between an endpoint and a TND of the first optical trail, or may be transmitted between an endpoint and a TND of the first optical trail, but on a UDI link not included as part of the first optical trail. In either the former or the latter case, the optical trail signal may be referred to as being transmitted “out-of-band”.

For example, for a first optical trail (existing or to be created) between IUD 8 and IUD 6 that includes UDI link 22, an optical trail signal corresponding to the first optical trail and transmitted on UDI link 24, which may be an optical link or an electrical link (e.g., 10BaseT Ethernet link), is an out-of-band optical trail signal. Further, for such a first optical trail, an optical trail signal corresponding to the first optical trail transmitted between IUD 12 and TND 46 (which may be the requesting device) on either UDI link 30 or 32 is an out-of-band optical trail signal.

Returning to FIG. 6A, in Act 102, it may be determined whether the trail creation signal is valid. For example, the TNC may be configured to determine if the trail creation signal includes a digital signature. Further, the TNC may be configured to authenticate whether the digital signature, if included in the trail creation signal, is that of the requesting device.

Further, as part of Act 102, the TNC may be configured to verify that the requesting device, and the two UDs specified by endpoint IDs 302 and 304 all belong to the user group specified by User Group ID 305. The validation acts described in relation to Act 102, or similar validation acts, also may be performed by the TNC in response to receiving other optical trail signals.

If it is determined in Act 102 that either the digital signature or the user group ID specified by the trail creation signal is not valid, then the optical trail may not be created, and the requesting device may be notified that the optical trail will not be created.

If it is determined in Act 102 that the trail creation signal is valid, then, in Act 104, it may be determined whether a path exists across the ON 4 that satisfies the optical trail parameters specified by the optical trail request.

Specifically, the TNC, using any of a variety of known techniques, may determine whether an optical trail may be created across the OTN 4 between a first IUD specified by the first endpoint ID 302 and the second IUD specified by a second endpoint ID 304 that satisfies the optical trail parameters specified by the one or more trail parameter signals 306 of the trail creation signal 300. For example, such a determination may be made as described in the Awduche reference.

For example, in response to the trail creation signal, the TNC may determine whether an optical trail may be created having a SONET physical layer with a size of OC-48 and a guarantee of 10 hours of bandwidth per year.

Although one or more UDs of the network 2 may know (i.e., store representations of and/or information about) the internal topology of OTN 4, because network resources of the OTN 4 determine whether an optical trail may be created across the OTN 4, it is not necessary for the UDs of network 2 to store such information or representations.

The ONC, e.g., the TNC, may be configured such that if one or more optical trail parameters are not specified, the values for these parameters may be determined from the specified endpoints. For example, if a physical layer indicator and/or size indicator are not specified by the one or more characteristic signals 306, the physical layer technology and size may be determined based on the first endpoint ID 302 and the second endpoint ID 304. For example, to make such a determination, the TNC may be configured to access a database, such as the MIB described above, that includes information about the endpoints and ports of the endpoints, including the bandwidth capacity and physical layer implementation of the UDI link associated with a port.

For each of the endpoint IDs 302 and 304 of the trail creation signal 300, if the endpoint ID specifies an IP address, the TNC may be configured to determine each port of the endpoint registered with the IP address, to determine which of these ports satisfies the optical trail parameters, and to select one of the ports to serve as an endpoint of the optical trail. If the endpoint ID specifies a particular port, for example, by specifying an ifIndex of a port, then the TNC may be configured to determine whether the particular port, or any channels for the port, satisfy the optical trail parameters. If the endpoint ID specifies a channel, e.g., a time slot, of an IUD port, then the TNC may be configured to determine whether the particular channel satisfies the optical trail parameters specified by the trail creation signal.

The TNC may determine whether a channel, port, or IP address satisfies the optical trail parameters of a trail creation signal by accessing a database, for example, a table of the MIB described above.

If it is determined in Act 104 that a path does not exist that satisfies the optical trail parameters specified in the trail creation signal, then, in Act 106, the TNC may notify the requesting device that an optical trail that satisfies the optical trail parameters cannot be created.

If it is determined in Act 104 that a path does exist that satisfies the optical trail parameters, then, in Act 108, it may be assessed whether there is more than one path that satisfies the optical trail parameters. If in Act 108, it is assessed that there is not more than one path that satisfies the optical trail parameters, then in Act 114, the IUDs that will serve as endpoints for the optical trail, i.e., those identified by first endpoint ID 302 and second endpoint ID 304, may be notified that the optical trail is being created.

Next, in Act 116, it may be determined whether either of the endpoints rejects the optical trail. For example, IUD 12 may reject an attempt by UD 10 to create an optical trail between IUD 12 and IUD 8.

If either of the endpoints rejects the attempt to create the optical trail, then in Act 110, it may be determined whether there are any remaining previously-determined paths that have not yet been rejected by either of the endpoints.

Alternatively, if it is determined in Act 116 that either of the endpoints has rejected the attempt, the method 101 may proceed directly to Act 106, or, as another alternative, proceed directly to Act 112.

Act 110 also may be reached if it is assessed in Act 108 that there is more than one path that satisfies the optical trail parameters. Alternatively, if in Act 108 it is assessed that there is more than one such path, the method 101 may proceed directly to Act 112, described below.

If, in Act 110, it is determined that there are not remaining paths across the OTN 4 that have not yet been rejected by one of the two endpoints, then, in Act 106, the requesting device is notified that an optical trail that satisfies the optical trail parameters cannot be created, specifically, because each of the one or more possible paths have been rejected by a requested endpoint.

If, in Act 110, it is determined that there is at least one remaining path not yet rejected by one of the two IUDs, then, in Act 112, one of the remaining paths is selected to be used for the optical trail, and in Act 114, both IUDs are notified that an optical trail will be created between them.

If in Act 116, it is determined that neither of the endpoints has rejected the selected optical trail (possibly the only selection available), then, in Act 118, an optical trail is created between the IUD specified by the first endpoint ID 302 and the IUD specified by the second endpoint ID 304.

In Act 120, the TNC may notify the requesting device that the optical trail has been created or is going to be created.

The TNC may be configured to assign an optical trail number for the created optical trail. This optical trail number may be stored in a database, for example, in the MIB, and later used to identify an optical trail.

The created optical trail may be configured to transmit data in accordance with any of a variety of protocols. For example, data may be transmitted on the UDI links of the optical trail in accordance with SONET, for example, as part of the payload of a SONET frame.

The optical trail may be comparable to a leased line connecting the two endpoints, where such a leased line is connection-based, as opposed to packet-based, and the OTN 4 does not implement queuing or other packet-based quality of service functions, but leaves such functions to the UDs of the network 2. Accordingly, each TND on the optical trail may be configured to circuit switch (i.e., space-division switch) data as opposed to packet-switching data.

Optionally, the optical trail may be configured to transmit data in accordance with the Gigabit Ethernet (GE) LAN protocol, e.g., full-duplex GE.

After the optical trail has been created between the two endpoints, subsequent optical trail signals to an TNC may specify the optical trail using any of a variety of identification techniques. Specifically, optical trail signals may specify an optical trail using either a complete specification of either endpoint of the optical trail, or a combination of an IP address associated with one or more ports of an endpoint and the optical trail ID assigned to the optical trail by the TNC. A complete specification of an endpoint includes an identification of a port of the endpoint, for example, an ifIndex, and, if the port is divided into multiple channels, an identification of the channel. For example, if a port is divided into multiple SONET time slots, the optical trail identifier may include an identification of the time slot corresponding to the optical trail.

A UD of the network 2 also may be configured to transmit to a TNC a delete signal requesting the deletion of an optical trail to a TNC. The TNC may be configured to delete the optical trail in response to receiving the deletion signal.

A UD may transmit a query signal to the TNC, where the query signal requests a status of an optical trail, for example, “created” or “not created.” In response to the query signal, the TNC may determine whether the requested optical trail has been created yet, for example, by accessing an MIB, and then send a status signal to the UD indicating the status of the optical trail.

A UD may be configured to send a destructive modify signal or a non-destructive modify signal to the TNC. A modify signal requests the TNC to modify a bandwidth characteristic of an existing optical trail. For example, the modification signal may request that the TNC decrease an amount of bandwidth provisioned for an optical trail, or change the priority of an optical trail in relation to other connections. The TNC may be configured to grant the requested modification by either changing the existing optical trail in accordance with the request or by deleting the existing optical trail and creating a new optical trail according to changes specified by the modification signal. Deleting and creating a new optical trail to implement a modification may result in communication errors between the endpoints during an interim between deletion and creation.

A non-destructive modify signal is similar to the modification signal except that the non-destructive modification signal specifies that the optical trail is not to be destroyed to grant the requested modification. Granting the modification request without deleting the optical trail ensures that communication errors will not occur between the endpoints as a result of modifying the optical trail. If the requested modification cannot be performed without deleting the signal, the request may not be granted.

A UD also may be configured to transmit a directory look-up signal to the TNC. A directory look-up signal requests the TNC to obtain a list of IUDs of the network 2 for which the requesting device can establish optical trails. The TNC may respond to the directory look-up signal by determining the IUDs of the network 2 for which the requesting device can request creation of an optical trail, and return one or more signals to the requesting device specifying such IUDs. The TNC may determine such endpoints by accessing a database, such as the MIB described above. The list of endpoints returned to the requesting device may identify each endpoint by an IP address, a port index (e.g., an ifIndex), other identification values, or any combination thereof.

Optionally, the TNC may be configured to limit the returned endpoint identifications to endpoints registered within the same user group as the requesting device. In addition, a UD may be configured to request, or an TNC may be configured to return, endpoints identifications of endpoints satisfying certain criteria. For example, UD may include in the directory look-up signal an indication to return only endpoint IDs of endpoints having a SONET physical layer interface to the OTN 4.

Any of the optical trail signals described herein may be transmitted in accordance with any of a variety of protocols, for example, an Ethernet protocol such as GE. Optionally, the optical trail signal may be encoded at the physical layer of the protocol along with other data, for example, as described in the Barry application. For example, if the protocol used for exchanging data between network devices is GE, which uses an 8B/10B block encoding scheme to encode data at the physical layer, one or more optical trail signals may be divided into 8-bit sequences, and these 8-bit sequences may be encoded at the physical layer level as one or more 10-bit sequences that are not defined for use by GE as code words or K-characters. These 10-bit sequences then may be multiplexed with other 10-bit GE sequences, including 10-bit code words and K-characters to produce a data stream. The UD or TND that receives this data stream then may de-multiplex the 10-bit sequences that encode an optical trail signal, and decode the 10-bit sequences as described in the Barry application. GE is described in more detail in Gigabit Ethernet, Technology Applications for High-Speed LANs, by Rich Seifert, published by Addison-Wesley, 1998, which is hereby incorporated by reference in its entirety.

The signaling techniques of OTNUDI, including creating, transmitting and responding to optical trail signals, as described above, may be implemented as described in Appendix III or as described in Appendix V, which is a copy of “Optical Domain Service Interconnect (ODSI) Signaling Control Specification” Version 1.4.5, by K. Arvind et al., ODSI Coalition, ODSI Signaling Control, November 2000.

6. OTNUDI Applications

OTNUDI, including the service discovery, address registration and optical trail signaling described above, may be used to implement a variety of applications. For example, an application may be defined to use OTNUDI to create an optical trail across an OTN in response to network traffic, for example, network traffic between two or more UDs.

FIG. 8 is a block diagram illustrating an example embodiment of a logical topology 388 of the network 2 of FIG. 1. IUD 6 is connected to IUD 14 by a logical connection 390, IUD 14 is connected to IUD 12 by logical connection 392 and IUD 12 is connected to IUD 8 by logical connection 393. Each of the logical connections 390, 392 and 393 may be any of a variety of logical connections, for example, a leased line (e.g., an optical trail) across the OTN 4, or a leased line or virtual circuit external to the OTN 4. Each of the IUDs 6, 14, 12 and 8, and other UDs and TNDs of the network 2 may include a topology database, possibly as part of an MIB as described above, that stores a representation of the logical topology 388.

This logical topology 388 allows the IUDs 6, 14, 12 and 8 to communicate, for example, in adherence to the TCP and IP protocols, and allows these IUDs to learn each others' IP addresses using traditional techniques. Further, each of the IUDs 6, 14, 12 and 8 may learn each other's IP addresses by transmitting a look-up signal to a TND of the OTN 4, which may return a signal specifying identifications of the other IUDs as described above in relation to optical trail signals.

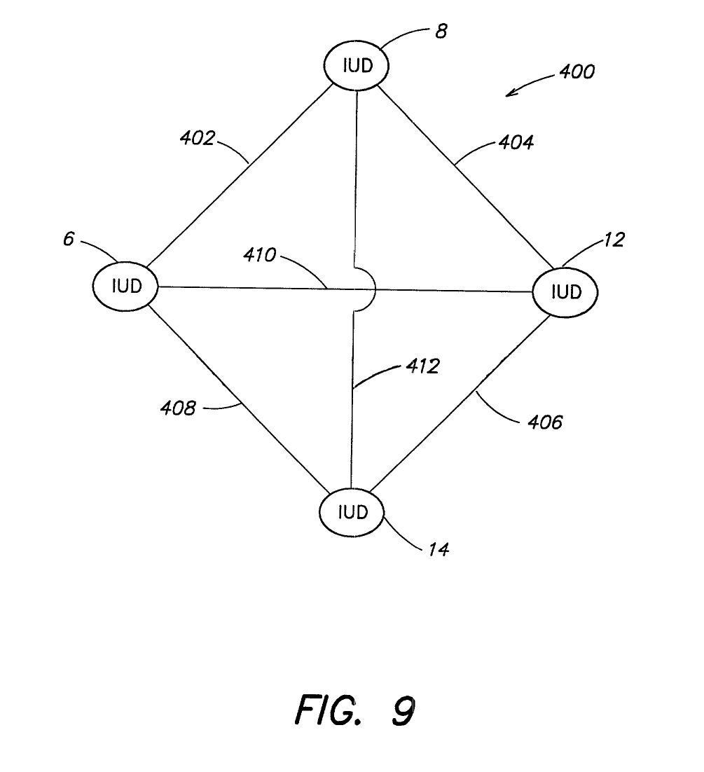

Logic contained in one or more of the IUDs 6, 14, 12 and 8 or other network resources may maintain a representation of a full-mesh of Label Switched Paths (LSPs) between each pair of IUDs 6, 14, 12 and 8, for example, as illustrated in FIG. 9.

FIG. 9 is a block diagram illustrating an example embodiment of a full-mesh overlay 400 of LSPs between IUDs 6, 14, 12 and 8 of the network 2 of FIG. 1. Full-mesh overlays and LSPs are described in more detail in RFC 2702. Such a full-mesh overlay 400 may include an LSP 402 between IUD 6 and IUD 8, an LSP 410 between IUD 6 and IUD 12, an LSP 408 between IUD 6 and IUD 14, an LSP 404 between IUD 8 and IUD 12, an LSP 412 between IUD 8 and IUD 14 and an LSP 406 between IUD 14 and IUD 12.

Assuming that logical topology 388, including logical connections 390, 392 and 393, is the only logical topology known by (i.e., for which a representation is available to) IUDs 6, 14, 12 and 8, then each of the LSPs 402-412 uses the logical connections 390, 392 and 393 to exchange data with the other IUDs of the full mesh overlay 400.

Assume that, using known traffic engineering and constraint-based routing techniques, for example, those described in RFC 2702 and/or the Katz reference, it initially is estimated that the network traffic between each pair of IUDs 6, 8, 12 and 14 along LSPs 402-412 is approximately 622 Mbps (i.e., approximately SONET level OC-12 or STS-12, or SDH level STM-4).

Accordingly, to accommodate the traffic requirements of the LSPs 402-412, the network traffic on both logical connections 390 and 393 is approximately 1.866 Gbps (i.e., SONET level OC-36 or STS-36), and the network traffic across logical connection 392 is approximately 2.488 Gbps (i.e., SONET level OC-48 or STS-48, or SDH level STM-16).

Further, assume that the bandwidth (i.e., bit transfer rate) capacity of each of the logical connections 390, 392 and 393 is approximately 2.488 Gbps. Therefore, the estimated traffic across logical connection 392 is at the bandwidth capacity of logical connection 392, 2.488 Gbps.

If it is then estimated, using traffic engineering and constraint-based routing techniques, that the network traffic between any of LSPs 402, 406, 410 or 412 will exceed 622 Mbps, then one or more of the IUDs 6, 14, 12 and 8, another network resource, or a combination thereof, may be configured to initiate creation of a new logical connection to handle some of the network traffic between IUD 14 and IUD 12. This new connection may be created external to the OTN 4 using known techniques. Alternatively, an optical trail may be created across OTN 4 as described above in relation to FIGS. 6A-6B.

This new optical trail may be created across the OTN 4 between IUD 14 and IUD 12 or between the two IUDs corresponding to the LSP that is estimated to have greater network traffic. For example, referring to FIGS. 8 and 9, if it is estimated that the network traffic between IUD 6 and IUD 8 will increase to a bit transfer rate that exceeds the bandwidth capacity of logical connection 392, then an optical trail may be created across the OTN 4 between IUD 14 and IUD 12 or IUD 6 and IUD 8, e.g., as described above in relation to FIGS. 6A-6B. Data can then be exchanged between IUD 6 and IUD 8 on the new optical trail.

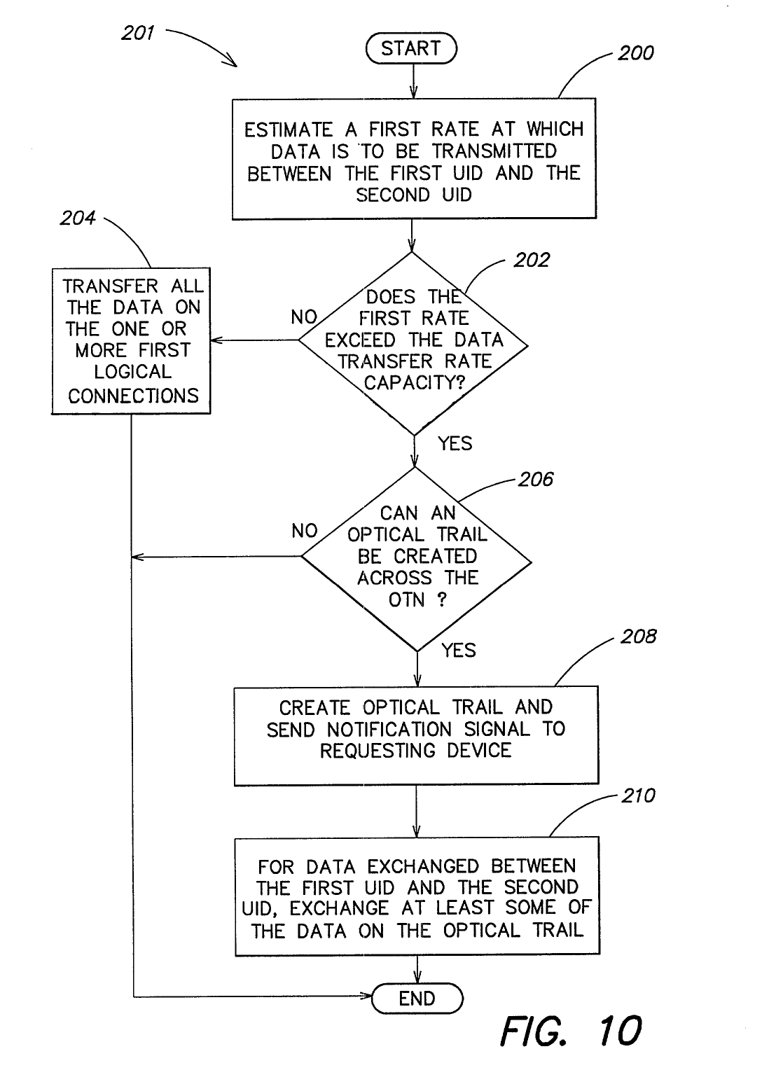

FIG. 10 is a flowchart illustrating an example embodiment of a method 201 of creating an optical trail across an OTN, e.g., OTN 4, between a first IUD and a second IUD in response to network traffic between the first IUD and the second IUD. The first IUD and second IUD may be connected by one or more first logical connections, where each of the first logical connections may be either a connection across the OTN (e.g., an optical trail) or a connection external to the OTN. The one or more first logical connections may have a combined bandwidth capacity, for example, 2.488 Gbps.

In Act 200, a first rate at which data is to be transmitted between the first IUD and the second IUD may be estimated, for example, using known traffic engineering and/or constraint-based routing techniques. For example, one or more LSPs having estimated data transfer rates may include the first IUD and the second IUD. Accordingly, each of these LSPs may be configured to use one of the first logical connections between the first IUD and the second IUD.

In a next Act 202, it may be determined whether the first rate exceeds the combined bandwidth capacity of the one or more first logical connections.

If it is determined in Act 202 that the first rate does not exceed the combined bandwidth capacity, then, in Act 204, data transferred between the first IUD and the second IUD may be transferred exclusively on the one or more first logical connections. Further, the configuration of the LSPs that use any of the one or more first logical connection may remain unchanged.

If it is determined in Act 202 that the first rate exceeds combined bandwidth capacity, then, in Act 206, it may be determined whether an optical trail may be created across the OTN between the first IUD and the second IUD. For example, a trail creation signal may be sent from a requesting device, which may be either the first IUD, the second IUD or another UD, to a TNC of the OTN. This trail creation signal may request that an optical trail be created across the OTN between the first UD and the second UD. The trail creation signal may include trail parameters that specify that the optical trail have a bandwidth capacity sufficient to handle the excess traffic between the first and second IUDs.

If it is determined in Act 206 that an optical trail can be created across the OTN between the first IUD and the second IUD that satisfies the trail parameters, then, in Act 288, the TNC, one or more other resources of the OTN or a combination thereof may create the optical trail and send a notification signal to the requesting device indicating that the requested optical trail has been created.

In a following Act 210, to satisfy the estimated traffic requirements between the first IUD and the second IUD, some of the data, e.g., the data in excess of the bandwidth capacity of the one or more first logical connections, to be exchanged between the first IUD and the second IUD may be exchanged on the created optical trail. Further, any LSPs that use any of the one or more first logical connections may be reconfigured using known techniques to use the bandwidth provided by the created optical trail.

If it is determined in Act 206 that an optical trail between the first and second IUDs that satisfies the trail parameters cannot be created, then an alternative action may be taken, for example, creating another logical connection between the first and second IUDs that is external to the OTN.

Further, determining whether to create such an external logical connection or, alternatively, an optical trail may be a determination incorporated into the method 201, for example, prior to Act 202.

Having now described some illustrative embodiments, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or apparatus elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of determining an ability of a first device to use an optical trail to communicate across an optical transport network with one or more other devices, wherein the first device and the one or more other devices are external to the optical transport network, the method comprising acts of:
(a) receiving at an input of a first transport network device of the optical transport network a first signal from the first device, the first signal indicating that at least a first port of the first device is available to be an endpoint for an optical trail across the optical transport network; and
(b) transmitting from the first transport network device to the first device a second signal identifying a second port of a second transport network device included in the optical transport network to which the first device can send signals corresponding to an optical trail.

2. The method of claim 1, further comprising:
(c) transmitting the first signal from the first device; and
(d) receiving the second signal at the first device.

3. The method of claim 1, further comprising an act of:
(c) determining the second port to which the first device can send signals corresponding to an optical trail.

4. The method of claim 1, wherein the first signal is included in a Synchronous Optical Network frame.

5. The method of claim 4 wherein the request signal is included in overhead bytes of the Synchronous Optical Network frame.

6. The method of claim 1, wherein acts (a) and (b) are performed in accordance with the Point-to-Point Protocol.

7. The method of claim 1, wherein the first signal is received from the first port of the first device.

8. The method of claim 1, wherein the first signal identifies a user group to which the first port belongs.

9. The method of claim 1, wherein the first signal includes a digital signature corresponding to the first device.

10. The method of claim 1, wherein the first signal comprises one or more port characteristic signals, each port characteristic signal indicating a characteristic of the first port.

11. The method of claim 9, wherein at least one of the characteristic signals indicates an ability of the first port to support concurrently a plurality of channels.

12. The method of claim 1, wherein the second signal comprises an acknowledge signal acknowledging that the first port is available to be allocated an optical trail.

13. The method of claim 1, wherein the second signal further comprises one or more port characteristic signals, each port characteristic signal indicating a characteristic of the second port of the first transport network device.

14. The method of claim 13, wherein at least one of the port characteristic signals indicates an ability of the second port to process concurrently a plurality of channels associated with the first port.

15. The method of claim 1, wherein the second transport network device is the first transport network device.

16. The method of claim 1, wherein the second transport network device is not the first transport network device.

17. The method of claim 1, wherein the first device is physically interfaced to the first transport network device by at least a first link.

18. The method of claim 17, wherein the first link is an optical link.

19. The method of claim 1, wherein the first transport network device is capable of receiving and transmitting optical signals.

20. The method of claim 1, wherein the second transport network device capable of receiving and transmitting signals.

21. A system for determining an ability of a first device to use an optical trail to communicate across an optical transport network with one or more other devices, wherein the first device and the one or more other devices are external to the optical transport network, the system comprising:
a first transport network device included as part of the optical transport network, the first transport network device comprising an input to receive a first signal from the first device, the first signal indicating that at least a first port of the first device is available to be an endpoint for an optical trail across the optical transport network, and an output to transmit to the first device a second signal identifying a second port of a second transport network device included in the optical transport network to which the first device can send signals corresponding to the optical trail.

22. The system of claim 21, wherein the system further comprises the first device, wherein the first device comprises an output to transmit the first signal and an input to receive the second signal.

23. The system of claim 21, wherein the first transport network device further comprises:
logic to determine the second port of the second transport network device.

24. The system of claim 21, wherein the input and the output are a same port of the first optical transport network device.

25. The system of claim 21, wherein the first signal is included in a Synchronous Optical Network frame.

26. The system of claim 25, wherein the first signal is included in overhead bytes of the Synchronous Optical Network frame.

27. The system of claim 21, wherein the input is operative to receive the first signal in accordance with the Point-to-Point Protocol, and the output is operative to transmit the second signal in accordance with the Point-to-Point Protocol.

28. The system of claim 21, wherein the first signal is received from the first port of the first device.

29. The system of claim 21, wherein the first signal identifies a user group to which the first port belongs.

30. The system of claim 21, wherein the first signal includes a digital signature corresponding to the first device.

31. The system of claim 21, wherein the first signal comprises one or more port characteristic signals, each port characteristic signal indicating a characteristic of the first port.

32. The system of claim 31, wherein at least one of the characteristic signals indicates an ability of the first port to support concurrently a plurality of channels.

33. The system of claim 21, wherein the second signal comprises an acknowledge signal acknowledging that the first port is available to be allocated an optical trail.

34. The system of claim 21, wherein the second signal further comprises one or more port characteristic signals, each port characteristic signal indicating a characteristic of the second port.

35. The system of claim 34, wherein at least one of the port characteristic signals indicates an ability of the second port to process concurrently a plurality of channels associated with the first port.

36. The system of claim 21, wherein the second transport network device is the first transport network device.

37. The system of claim 21, wherein the second transport network device is not the first transport network device.

38. The system of claim 21, wherein the first device is physically interfaced to the first transport network device by at least a first link.

39. The system of claim 38, wherein the first link is an optical link.

40. The system of claim 21, wherein the first transport network device is capable of receiving and transmitting optical signals.

41. The system of claim 21, wherein the second transport network device is capable of receiving and transmitting optical signals.

42. A system for determining an ability of a first device to use an optical trail to communicate across an optical transport network with one or more other devices, wherein the first device and the one or more other devices are external to the optical transport network, the system comprising:
means for receiving a first signal from the first device, the first signal indicating that at least a first port of the first device is available to be an endpoint for an optical trail across the optical transport network; and
means for transmitting from the first transport network device to the first device a second signal identifying a second port of a second transport network device included in the optical transport network to which the first device can send signals corresponding to an optical trail.

43. The system of claim 42, further comprising:
means for transmitting the first signal from the first device; and
means for receiving the second signal at the first device.

44. The system of claim 42, further comprising:
means for determining the second port to which the first device can send signals corresponding to an optical trail.

45. The system of claim 42, where in the first signal is included in a Synchronous Optical Network frame.

46. The system of claim 45, wherein the request signal is included in overhead bytes of the Synchronous Optical Network frame.

47. The system of claim 42, wherein the means for receiving is operative to receive the first signal in accordance with the Point-to-Point Protocol, and the means for transmitting is operative to transmit the second signal in accordance with the Point-to-Point Protocol.

48. The system of claim 42, wherein the first signal is received from the first port of the first device.

49. The system of claim 42, wherein the first signal identifies a user group to which the first port belongs.

50. The system of claim 42, wherein the first signal includes a digital signature corresponding to the first device.

51. The system of claim 42, wherein the first signal comprises one or more port characteristic signals, each port characteristic signal indicating a characteristic of the first port.

52. The system of claim 51, wherein at least one of the characteristic signals indicates an ability of the first port to support concurrently a plurality of channels.

53. The system of claim 42, wherein the second signal comprises an acknowledge signal acknowledging that the first port is available to be allocated an optical trail.

54. The system of claim 42, wherein the second signal further comprises one or more port characteristic signals, each port characteristic signal indicating a characteristic of the second port of the first transport network device.

55. The system of claim 54, wherein at least one of the port characteristic signals indicates an ability of the second port to process concurrently a plurality of channels associated with the first port.

56. The system of claim 42, wherein the second transport network device is the first transport network device.

57. The system of claim 42, wherein the second transport network device is not the first transport network device.

58. The system of claim 42, wherein the first device is physically interfaced to the first transport network device by at least a first link.

59. The system of claim 58, wherein the first link is an optical link.

60. The system of claim 42, wherein the first transport network device is capable of receiving and transmitting optical signals.

61. The system of claim 42, wherein the second transport network device capable of receiving and transmitting signals.

62. A computer program product, comprising:
computer readable medium; and
computer readable signals stored on the computer readable medium that define instructions that, as a result of being executed by a computer, instruct the computer to perform a process of determining an ability of a first device to use an optical trail to communicate across an optical transport network with one or more other devices, wherein the first device and the one or more other devices are external to the optical transport network, the process comprising acts of:
(a) receiving at an input of a first transport network device of the optical transport network a first signal from the first device, the first signal indicating that at least a first port of the first device is available to be an endpoint for an optical trail across the optical transport network; and
(b) transmitting from the first transport network device to the first device a second signal identifying a second port of a second transport network device included in the optical transport network to which the first device can send signals corresponding to an optical trail.

63. A method of determining an ability of a first device to use an optical trail to communicate across an optical transport network with one or more other devices, wherein the first device and the one or more other devices are external to the optical transport network, the method comprising acts of:
(a) transmitting to a first transport network device of the optical transport network a first signal from the first device, the first signal indicating that at least a first port of the first device is available to be an endpoint for an optical trail across the optical transport network; and
(b) receiving from the first transport network device a second signal identifying a second port of a second transport network device included in the optical transport network to which the first device can send signals corresponding to an optical trail.

64. The method of claim 63, further comprising:
(c) receiving the first signal at the first transport network device; and
(d) transmitting the second signal from the first transport network device.

65. The method of claim 64, further comprising an act of:
(e) determining the second port to which the first device can send signals corresponding to an optical trail.

66. The method of claim 63, wherein the first signal is included in a Synchronous Optical Network frame.

67. The method of claim 66, wherein the request signal is included in overhead bytes of the Synchronous Optical Network frame.

68. The method of claim 63, wherein acts (a) and (b) are performed in accordance with the Point-to-Point Protocol.

69. The method of claim 63, wherein the first signal is transmitted from the first port of the first device.

70. The method of claim 63, wherein the first signal identifies a user group to which the first port belongs.

71. The method of claim 63, wherein the first signal includes a digital signature corresponding to the first device.

72. The method of claim 63, wherein the first signal comprises one or more port characteristic signals, each port characteristic signal indicating a characteristic of the first port.

73. The method of claim 72, wherein at least one of the characteristic signals indicates an ability of the first port to support concurrently a plurality of channels.

74. The method of claim 63, wherein the second signal comprises an acknowledge signal acknowledging that the first port is available to be allocated an optical trail.

75. The method of claim 63, wherein the second signal further comprises one or more port characteristic signals, each port characteristic signal indicating a characteristic of the second port of the first transport network device.

76. The method of claim 75, wherein at least one of the port characteristic signals indicates an ability of the second port to process concurrently a plurality of channels associated with the first port.

77. The method of claim 63, wherein the second transport network device is the first transport network device.

78. The method of claim 63, wherein the second transport network device is not the first transport network device.

79. The method of claim 63, wherein the first device is physically interfaced to the first transport network device by at least a first link.

80. The method of claim 79, wherein the first link is an optical link.

81. The method of claim 63, wherein the first transport network device is capable of receiving and transmitting optical signals.

82. The method of claim 63, wherein the second transport network device is capable of receiving and transmitting optical signals.

83. A system for determining an ability of a first device to use an optical trail to communicate across an optical transport network with one or more other devices, wherein the first device and the one or more other devices are external to the optical transport network, the system comprising:
the first device comprising an output to transmit to a first transport network device of the optical transport network a first signal, the first signal indicating that at least a first port of the first device is available to be an endpoint for an optical trail across the optical transport network, and an input to receive from the first transport network device a second signal identifying a second port of a second transport network device included in the optical transport network to which the first device can send signals corresponding to an optical trail.

84. The system of claim 83, further comprising:
the first transport network device comprising an input to receive the first signal and an output to transmit the second signal.

85. The system of claim 84, wherein the first transport network device further comprises logic to determine the second port to which the first device can send signals corresponding to an optical trail.

86. The system of claim 83, wherein the input and the output are a same port of the first device.

87. The system of claim 83, wherein the first signal is included in a Synchronous Optical Network frame.

88. The system of claim 87, wherein the first signal is included in overhead bytes of the Synchronous Optical Network frame.

89. The system of claim 83, wherein the input is operative to receive the second signal in accordance with the Point-to-Point Protocol, and the output is operative to transmit the first signal in accordance with the Point-to-Point Protocol.

90. The system of claim 83, wherein the first signal is transmitted from the first port of the first device.

91. The system of claim 83, wherein the first signal identifies a user group to which the first port belongs.

92. The system of claim 83, wherein the first signal includes a digital signature corresponding to the first device.

93. The system of claim 83, wherein the first signal comprises one or more port characteristic signals, each port characteristic signal indicating a characteristic of the first port.

94. The system of claim 93, wherein at least one of the characteristic signals indicates an ability of the first port to support concurrently a plurality of channels.

95. The system of claim 83, wherein the second signal comprises an acknowledge signal acknowledging that the first port is available to be allocated an optical trail.

96. The system of claim 83, wherein the second signal further comprises one or more port characteristic signals, each port characteristic signal indicating a characteristic of the second port of the first transport network device.

97. The system of claim 96, wherein at least one of the port characteristic signals indicates an ability of the second port to process concurrently a plurality of channels associated with the first port.

98. The system of claim 83, wherein the second transport network device is the first transport network device.

99. The system of claim 83, wherein the second transport network device is not the first transport network device.

100. The system of claim 83, wherein the first device is physically interfaced to the first transport network device by at least a first link.

101. The system of claim 100, wherein the first link is an optical link.

102. The system of claim 83, wherein the first transport network device is capable of receiving and transmitting optical signals.

103. The system of claim 83, wherein the second transport network device is capable of receiving and transmitting optical signals.

104. A system for determining an ability of a first device to use an optical trail to communicate across an optical transport network with one or more other devices, wherein the first device and the one or more other devices are external to the optical transport network, the system comprising:
means for transmitting to a first transport network device of the optical transport network a first signal from the first device, the first signal indicating that at least a first port of the first device is available to be an endpoint for an optical trail across the optical transport network; and
means for receiving from the first transport network device a second signal identifying a second port of a second transport network device included in the optical transport network to which the first device can send signals corresponding to an optical trail.

105. The system of claim 104, further comprising:
means for receiving the first signal at the first transport network device; and
means for transmitting the second signal from the first transport network device.

106. The system of claim 105, further comprising an act of:
(e) determining the second port to which the first device can send signals corresponding to an optical trail.

107. The system of claim 104, wherein the first signal is included in a Synchronous Optical Network frame.

108. The system of claim 107, wherein the request signal is included in overhead bytes of the Synchronous Optical Network frame.

109. The system of claim 104, wherein the means for receiving is operative to receive the first signal in accordance with the Point-to-Point Protocol, and the means for transmitting is operative to transmit the second signal in accordance with the Point-to-Point Protocol.

110. The system of claim 104, wherein the first signal is received from the first port of the first device.

111. The system of claim 104, wherein the first signal identifies a user group to which the first port belongs.

112. The system of claim 104, wherein the first signal includes a digital signature corresponding to the first device.

113. The system of claim 104, wherein the first signal comprises one or more port characteristic signals, each port characteristic signal indicating a characteristic of the first port.

114. The system of claim 113, wherein at least one of the characteristic signals indicates an ability of the first port to support concurrently a plurality of channels.

115. The system of claim 104, wherein the second signal comprises an acknowledge signal acknowledging that the first port is available to be allocated an optical trail.

116. The system of claim 104, wherein the second signal further comprises one or more port characteristic signals, each port characteristic signal indicating a characteristic of the second port of the first transport network device.

117. The system of claim 116, wherein at least one of the port characteristic signals indicates an ability of the second port to process concurrently a plurality of channels associated with the first port.

118. The system of claim 104, wherein the second transport network device is the first transport network device.

119. The system of claim 104, wherein the second transport network device is not the first transport network device.

120. The system of claim 104, wherein the first device is physically interfaced to the first transport network device by at least a first link.

121. The system of claim 120, wherein the first link is an optical link.

122. The system of claim 104, wherein the first transport network device is capable of receiving and transmitting optical signals.

123. The system of claim 104, wherein the second transport network device capable of receiving and transmitting signals.

124. A computer program product, comprising:
computer readable medium; and
computer readable signals stored on the computer readable medium that define instructions that, as a result of being executed by a computer, instruct the computer to perform a process of determining an ability of a first device to use an optical trail to communicate across an optical transport network with one or more other devices, wherein the first device and the one or more other devices are external to the optical transport network, the method comprising acts of:
(a) transmitting to a first transport network device of the optical transport network a first signal from the first device, the first signal indicating that at least a first port of the first device is available to be an endpoint for an optical trail across the optical transport network; and
(b) receiving from the first transport network device a second signal identifying a second port of a second transport network device included in the optical transport network to which the first device can send signals corresponding to an optical trail.

125. A method of determining an ability of a first device to use an optical trail to communicate across an optical transport network with one or more other devices, wherein the first device and the one or more other devices are external to the optical transport network, the method comprising acts of:
(a) transmitting from the first device a first signal indicating that at least a first port of the first device is available to be an endpoint for an optical trail across the optical transport network;
(b) receiving the first signal at a first transport network device of the optical transport network;
(c) transmitting from the first transport network device a second signal identifying a second port of a second transport network device included in the optical transport network to which the first device can send signals corresponding to an optical trail; and
(d) receiving the second signal at the first device.

126. A system for determining an ability of a first device to use an optical trail to communicate across an optical transport network with one or more other devices, wherein the first device and the one or more other devices are external to the optical transport network, the system comprising:
the first device comprising a first output to transmit a first signal indicating that at least a first port of the first device is available to be an endpoint for an optical trail across the optical transport network, and comprising a first input to receive a second signal identifying a second port of a second transport network device included in the optical transport network to which the first device can send signals corresponding to an optical trail; and
a first transport network device comprising a second input to receive the first signal, and comprising a second output to transmit the second signal.

127. A system for determining an ability of a first device to use an optical trail to communicate across an optical transport network with one or more other devices, wherein the first device and the one or more other devices are external to the optical transport network, the system comprising:
means for transmitting from the first device a first signal indicating that at least a first port of the first device is available to be an endpoint for an optical trail across the optical transport network;
means for receiving the first signal at a first transport network device of the optical transport network;
means for transmitting from the first transport network device a second signal identifying a second port of a second transport network device included in the optical transport network to which the first device can send signals corresponding to an optical trail; and
means for receiving the second signal at the first device.

128. A computer program product, comprising:
computer readable medium; and
computer readable signals stored on the computer readable medium that define instructions that, as a result of being executed by a computer, instruct the computer to perform a process of determining an ability of a first device to use an optical trail to communicate across an optical transport network with one or more other devices, wherein the first device and the one or more other devices are external to the optical transport network, the method comprising acts of:
(a) transmitting from the first device a first signal indicating that at least a first port of the first device is available to be an endpoint for an optical trail across the optical transport network;
(b) receiving the first signal at a first transport network device of the optical transport network;
(c) transmitting from the first transport network device a second signal identifying a second port of a second transport network device included in the optical transport network to which the first device can send signals corresponding to an optical trail; and
(d) receiving the second signal at the first device.
